(19) United States
(12) Patent Application Publication
(10) Pub. No.: US 2009/0046345 A1
(43) Pub. Date: Feb. 19, 2009

(54) IMAGE FORMATION SYSTEM

(76) Inventor: Chien-Chiang Hsu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/873,416

(22) Filed: Oct. 17, 2007

(30) Foreign Application Priority Data
Aug. 14, 2007 (TW) 096130012

(51) Int. Cl. G02B 17/00

(52) U.S. Cl. 359/223; 359/726

(57) ABSTRACT

An image formation system includes a projection lens being a last optical component of the image formation system; a light pipe; a controlling device, for controlling the image formation system; a first curved surface optical component, for receiving and transmitting light from the light pipe; and a second curved surface optical component, for receiving the light from the first curved surface optical component and transmitting the light to the controlling device; wherein the first curved surface optical component and the second curved surface optical component make the light pipe and the controlling device image-conjugate.

### BACKGROUND OF THE INVENTION

1. Field of the Invention

The present invention relates to an image formation system, and particularly relates to an image formation system having two curved surface optical components.

2. Description of the Prior Art

Conventionally, a light path module of an image formation system (for example, a projector) needs a plurality of optical components such as a lens or a reflector to transmit light to a desired light path; for example, to transmit light to a DMD (Digital Micromirror Device).

FIG. 1 is a schematic diagram illustrating a prior art image formation system 100. As shown in FIG. 1, the image formation system 100 includes a light pipe 101, a condenser lens (or lens) 103, a fold mirror 105, a field lens (or lens) 107, and a controlling device 109 (for example, a DMD). As shown in FIG. 1, light passes through the light pipe 101 after passing through the condenser lens 103 and is transmitted to the fold mirror 105. The fold mirror 105 reflects light to the field lens 107. Thereafter, the field lens 107 transmits light to the controlling device 109 for controlling.

However, such a mechanism needs more than three optical components (condenser lens 103, fold mirror 105 and field lens 107). Thus the cost is higher, and the design of the light path is more complicated. Accordingly, a new invention is needed to simplify the system complexity and decrease the cost.

### SUMMARY OF THE INVENTION

Therefore, an objective of the present invention is to provide an image formation system, which can use fewer optical components to transmit light following a predetermined light path.

An embodiment of the present invention discloses an image formation system, comprising: a lens; a light pipe; a controlling device, for controlling the image formation system; a first curved surface optical component, for receiving and transmitting light from the light pipe; and a second curved surface optical component, for receiving the light from the first curved surface optical component and transmitting the light to the controlling device; wherein the first curved surface optical component and the second curved surface optical component make the light pipe and the controlling device image-conjugate.

According to the above-mentioned module and system, element numbers can be decreased and the design of light path can be simplified.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a prior art image formation system.

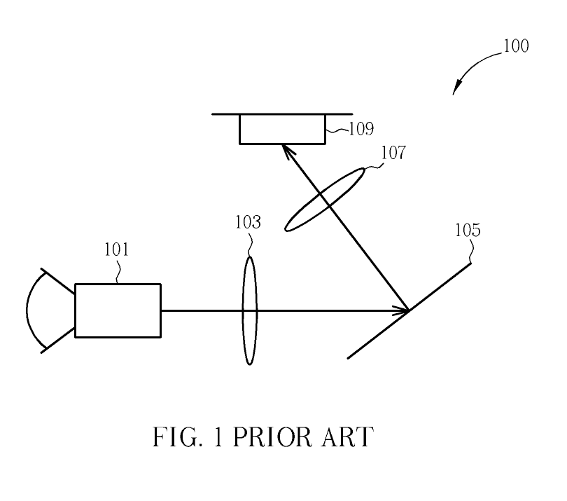

FIG. 2 is an image formation system according to a first embodiment of the present invention.

FIG. 3 is an image formation system according to a second embodiment of the present invention.

FIG. 4 is an image formation system according to a third embodiment of the present invention.

FIG. 5 is an image formation system according to a fourth embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to Also, the term “couple” is intended to mean either an indirect or direct electrical connection. Accordingly, if one device is coupled to another device, that connection may be through a direct electrical connection, or through an indirect electrical connection via other devices and connections.

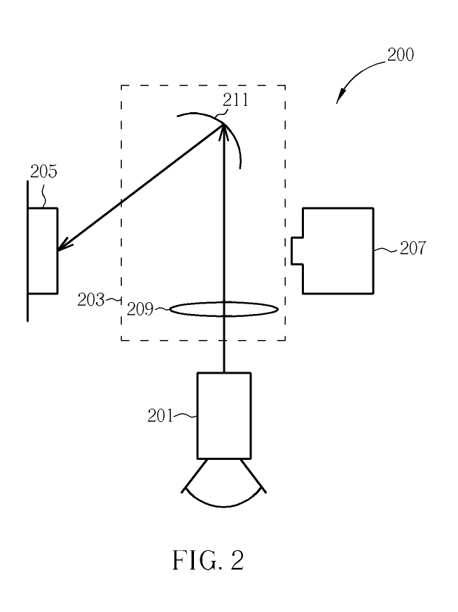

FIG. 2 is an image formation system according to a first embodiment of the present invention. It should be noted that, a projector is utilized as an example for an image formation system 200, but it does not mean to limit the scope of the present invention; the image formation system according to the present invention can be other image formation systems besides a projector. As shown in FIG. 2, the image formation system 200 includes a light pipe 201, a light path module 203, a controlling device 205, and a projection lens 207. The projection lens 207 is located on the outermost part of the projector, and is used for projecting the image to a target object such as a curtain; that is, the projection lens 207 is the final optical component in the predetermined light path in the image formation system 200. The light pipe 201 is used for transmitting light to the light module 203. In this embodiment, the light module 203 is utilized for transmitting light from the light pipe 201 to the controlling device 205. If the image formation system 200 is a projector, the controlling device 205 is a DMD.

In this embodiment, the light path module 203 includes two curved surface optical components 209 and 211. The curved surface optical component 211 is used for receiving light from the curved surface optical component 209 and for transmitting light to a predetermined light path. When the light module 203 is utilized in the image formation system 200, its characteristics (such as curve degrees of the curved surface optical components 209 and 211) are decided according to the controlling device 205 and the light pipe 201. The characteristics should make the light pipe 201 and the controlling device 205 image-conjugate. In the embodiment shown in FIG. 2, the curved surface optical component 209 is a transparent optical component, and the curved surface optical component 211 is a reflective optical component, but this is not meant to limit the scope of the present invention: the curved surface optical components 209 and 211 can be optical components of different types. Also, the arrangement of the surface optical components of the light path module 203 is not limited to the arrangement shown in FIG. 2. Besides, the arrangement of the light path module 203, the controlling device 205 and the projector lens 207 is not limited to the arrangement shown in FIG. 2, which will be explained as follows.

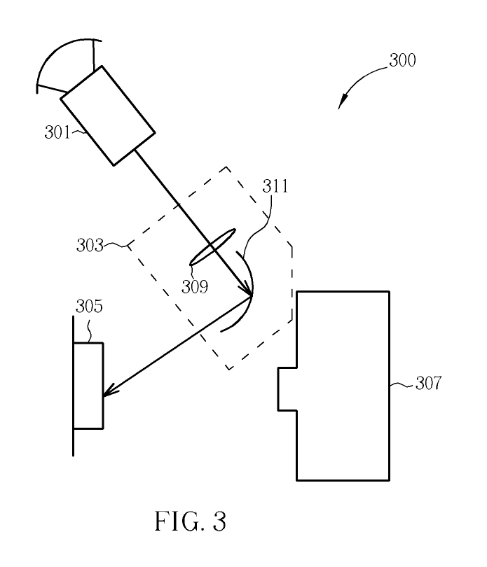

FIG. 3 is an image formation system according to a second embodiment of the present invention. Compared with the above-mentioned embodiment, the light path modules 203 and 303 both include a transparent optical component and a reflective optical component, and the arrangement of the curved surface optical component in the light path module 203 and 303 are similar. Although the arrangement of the light path module 303, the controlling device 305 and the projector lens 307 are different from that of the light path module 203, the controlling device 205 and the projector lens 207, the same function can still be reached.

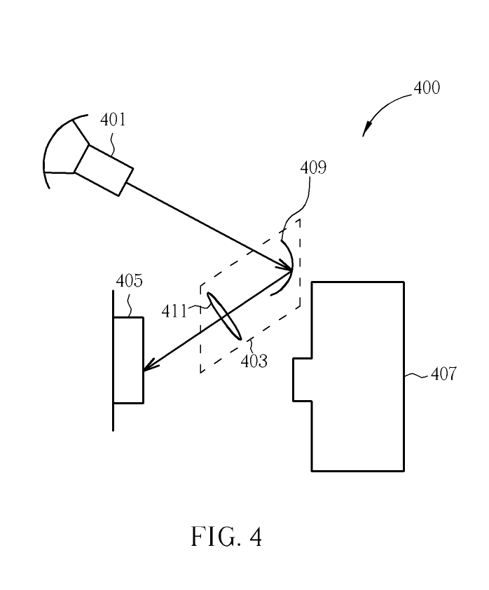

FIG. 4 is an image formation system according to a third embodiment of the present invention. In the embodiment shown in FIG. 4, the arrangement of the light path module 403, the controlling device 405 and the projector lens 407 is similar with that of the light path module 303, the controlling device 305 and the projector lens 307. Furthermore, the light path modules 403 and 303 both include a transparent optical component and a reflective optical component. Again, the arrangement of the curved surface optical components in the light path modules 303 and 403 are different. In the light path module 303, the curved surface optical component 309 for receiving light from the light pipe 301 is a transparent optical component, and the curved surface optical component 311 for transmitting light to the controlling device 305 is a reflective optical component. In the light path module 403, however, the curved surface optical component 409 for receiving light from the light pipe 401 is a reflective optical component, and the curved surface optical component 411 for transmitting light to the controlling device 405 is a transparent optical component.

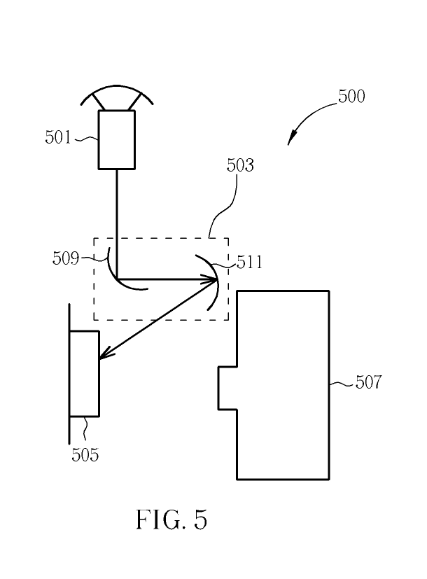

FIG. 5 is an image formation system according to a fourth embodiment of the present invention. In this embodiment, the curved surface optical components 509 and 511 of the light path module 503 are both reflective optical components. The arrangement of the light path module 503, the controlling device 505 and the projector lens 507 is different from that of the same elements in FIG. 2, FIG. 3 and FIG. 4, but the same function can also be reached.

According to the above-mentioned descriptions, the curved surface optical component in the light module according to the present invention is not limited to a particular type. Also, the arrangement between the light path module and the projector lens in the image formation system is not limited. According to the above-mentioned module, the number of elements can decrease and the complexity of light path design can be simplified.

Those skilled in the art will readily observe that numerous modifications and alterations of the device and method may be made while retaining the teachings of the invention.

1. An image formation system, comprising:
a projection lens being a last optical component of the image formation system;
a light pipe;
a controlling device, for controlling the image formation system;
a first curved surface optical component, for receiving and transmitting light from the light pipe; and
a second curved surface optical component, for receiving the light from the first curved surface optical component and transmitting the light to the controlling device;
wherein the first curved surface optical component and the second curved surface optical component make the light pipe and the controlling device image-conjugate.

2. The image formation system of claim 1, being a projector, wherein the controlling device is a digital micromirror device.

3. The image formation system of claim 1, wherein the first curved surface optical component is a transparent optical component, and the second curved surface optical component is a reflective optical component.

4. The image formation system of claim 1, wherein the first curved surface optical component is a reflective optical component, and the second curved surface optical component is a transparent optical component.

5. The image formation system of claim 1, wherein the first and second curved surface optical components are reflective optical components.

6. The image formation system of claim 1, wherein at least one of the first curved surface optical component and the second curved surface optical component is a curved surface lens or a curved surface reflector.
